(19) United States
(12) Patent Application Publication
(10) Pub. No.: US 2004/0105608 A1
(43) Pub. Date: Jun. 3, 2004

(54) Detecting damage in rails

(76) Inventor: Roger Mark Sloman, Derbyshire (GB)

Correspondence Address: SMITH-HILL AND BEDELL, 12670 N W BARNES ROAD, SUITE 104, PORTLAND, OR, 97229

(21) Appl. No.: 10/470,474

(22) PCT Filed: Jan. 29, 2002
(86) PCT No.: PCT/GB02/00389

(30) Foreign Application Priority Data
Jan. 30, 2001 (GB) 0102279.7
Jan. 30, 2001 (GB) 0102302.7
Jan. 30, 2001 (GB) 0102303.5
Mar. 2, 2001 (GB) 0105133.3

(51) Int. Cl. G02B 6/00

(52) U.S. Cl. 385/12

(57) ABSTRACT

A method of detecting damage in a rail includes the step of running a vehicle on the rail, detecting the sound produced by the rail as a result of the vehicle running on the rail and analyzing the detected sound to provide an indication of any damage to the rail. Alternatively or additionally, the light reflected by the rail (including laser light directed at the rail) and/or the temperature of the rail may be detected. The method is particularly aimed at detecting complete breaks in rails. the method may be carried out while the train is operating a normal commercial service, thus minimizing disruption and providing continuous analysis of the condition of the rail network.

The invention relates to a method and apparatus for detecting damage in rails and particularly to such a method and apparatus for detecting breaks in rails.

Damaged, cracked and broken rails present an ongoing and serious problem for railways. Cracks may be caused by various factors including, for example, fatigue resulting from contact with and load from rail vehicle wheels. Although cracks initially start small, in some circumstances they may develop until eventually they result in the rail breaking. Once a rail has broken in one location, it has been found that it often breaks subsequently in a second location nearby. For example, if a rail breaks in a location spaced from a sleeper, the rail then forms a cantilever supported on the sleeper and is subject to severe stresses at the point where it rests on the sleeper. This can quickly cause the rail to break also at that point, and this can result in the loss of a complete section of rail and possible subsequent derailment of trains.

Various different types of crack may form in rails and this can make their detection more difficult. For example, “head checking” involves the formation of initial small, fine cracks in the surface of the rail, typically near the gauge corner in curved rails. It may be found in rails less than a year old right through the age spectrum to rails that have been in track for thirty years and which have previously shown no signs of head checking. Often a substantial length of track is affected, for example the highly canted part of a curve.

Small head check cracks initially do not cause serious difficulties but, as trains run over the cracks, water/lubricants can be pushed into the cracks, causing them to enlarge. In cracks of over about 20 mm in surface length, downward branches may develop producing a risk of actual breakage of the rail.

Another type of cracking is referred to as “tongue lipping”. A crack initially develops from the side or gauge face of the rail, and extends upwardly therefrom. This results in a sliver of metal being separated from the bulk of the rail by the crack. As a train runs over the rail, this sliver of metal is beaten out to form a tongue and the crack continues to grow under the surface of the rail, burrowing under the rail crown. The crack burrows on a nearly horizontal plane beneath the rail crown and near vertical branches shoot up and down from it, creating a breakage risk.

A further type of crack is referred to as a “squat”. Typically, visible cracking starts near the edge of and at an angle to the running band on the gauge face side. The crack may develop under the surface of the rail, with surface shading showing the sub-surface development. Horizontal and vertical cracks may form.

Current testing methods aim to detect any of the above cracks at a relatively early stage, i.e. before the crack results in the breakage of the rail. Such current methods for detecting cracks include ultrasonic inspection on special vehicles (test units), ultrasonic inspection via hand operators and visual inspection.

There is a variety of different specialist test vehicles which are able to run at speeds of up to about 40 mph or 60 mph whilst checking the track and rails and these employ a number of ultrasonic and eddy current systems. Of the systems, only the ultrasonic technique is in widespread use, and the current ultrasonic test units tends to record a high number of false positives, which then must be checked manually. The units are also poor at detecting certain defects in the rail. For example, with head checking, there is a particular risk that “shielding” can occur. Because the ultrasound cannot penetrate through the cracks, one crack can prevent the ultrasonic beam from detecting a possibly more serious defect. In relation to tongue lipping, the shape, size and angle of the cracks mean that they cannot be detected reliably ultrasonically and, in relation to squats, a long horizontal defect can mask the existence of a transverse fatigue crack. Finally, where rails have been damaged by wheel burns, a martensite layer may form on the rail surface. The presence of this layer makes the rail untestable ultrasonically.

The eddy current technique is still being developed for rail inspection, but this also suffers from the same problems as make the ultrasonic system unreliable, and unable to cover any significant part of the track network length. In view of the above problems, in the U.K. hand operators have, until recently been relied upon for all ultrasonic testing of rails. Hand operators are able to take the time to size defects accurately. They use either hand-held probes for detailed work or a trolley equipped with an oscilloscope and a number of probes set at different angles. The trolley is hand-pushed and usually runs along a single rail.

There are problems with the above approach. In particular, the hand operators work at walking speed and therefore cannot cover a significant distance of rail. The operators have to focus on an oscilloscope signal as they walk along the track, over sleepers and on ballast. Some trolley designs give an automatic audio signal of defects found, but it is possible that defect indications can be missed during walking. Often trolley design does not provide a record of the track tested and recording is left to the operator. Thus, defects detected below the action levels, and allowed to remain in the track, can be lost. Finally, some trolley designs contains only two probes which run along the rail centre. Therefore, off-axis defects are difficult to detect.

A variety of trolley designs are used world-wide but all operate on similar principles, and all suffer similar problems of reliability, difficulty in interpretation of the result and inability to cover any significant length of track in a working day.

According to the invention there is provided a method of detecting damage in a rail, the method including the steps of running a vehicle on the rail, detecting sound produced by the rail as a result of the vehicle running on the rail and analysing the detected sound to provide an indication of damage to the rail.

The vehicle may be a train. Preferably the vehicle is a train running a normal commercial service. The vehicle may be travelling at a speed of at least 70 mph.

The sound may be detected continuously or periodically as the rail vehicle moves.

Preferably at least some of the sound detected is within the audible spectrum.

The sound may be produced by the vehicle wheels running on the track. Alternatively or additionally, the vehicle may be provided with additional means for contacting the rail and producing sound as the vehicle runs along the track.

The sound may be detected by a sound collection apparatus, which may include a microphone and may further include a sound collection tube or horn. A sound sensing apparatus may be positioned on the rail vehicle, either near the rail, or located remotely from the rail, and appropriately connected to the sound collection apparatus near the rail.

The method may include the step of partially or completely cancelling unwanted background sounds.

The method may also include the step of reducing interference caused by external airflow over the sound collection apparatus.

Preferably the detected sound is recorded. The sound may be analysed contemporaneously or, if recorded, the data may be analysed subsequently.

In order to minimise the volume of data recorded it is preferable to record only those acoustic events which are anomalous compared to the normal level.

Preferably the method includes the step of recording the position of the vehicle. The position may be calculated with reference to a start position and/or by trackside position indicators, which may be used to update the recorded position. Preferably, a satellite based global positioning system (GPS) is utilised.

Preferably the method includes the step of relating the detected sound to the position of the vehicle at the time the sound was detected.

The method may include the step of analysing the frequencies within the detected sound spectrum, for example by Fourier analysis or a similar method.

The analysed sound may be compared with a reference sound fingerprint based on the sound produced by an unbroken rail. Alternatively or additionally, the method may include the step of checking for particular frequencies present within the analysed sound, such frequencies tending to indicate damage. Alternatively or additionally the method may include the step of checking for the absence of particular frequencies within the analysed sound, the absence of such frequencies tending to indicate damage.

The method may include the step of checking for a drop in amplitude of the sound produced by the rail. Alternatively or additionally the method may include the step of checking for a significant increase in amplitude of the sound produced by the rail, in particular for a spike in the amplitude with respect to the position of the vehicle on the rail.

Alternatively or additionally, the method may include the step of simultaneously detecting the sound produced by the vehicle running on each of two adjacent rails in a pair of rails and comparing the analysed sound from each of the rails to check for abnormalities.

The method may include the step of recording the data for a particular track and comparing subsequent data for the same track with the previously recorded data, to detect any changes indicating rail damage.

The method may further include the step of detecting light reflected by an area on a surface of the rail and analysing the detected light to provide an indication of damage to the rail within the area.

By simultaneously detecting the sound produced by the vehicle running on the rail, and the light reflected by the surface of the rail, the method will pick up anomalies more reliably than by using sound alone.

Preferably the reflected light is detected continuously or periodically as the rail vehicle moves, the area on the surface of the rail thus continuously changing.

The method may utilise apparatus including a scanning head provided with light detection means, the method including the steps of mounting the apparatus on a rail vehicle, using the light detection means in the scanning head to produce an indication of levels of light reflected by an area on a surface, preferably a top surface, of the rail and analysing the output of the light detection means to provide an indication of damage to the rail within the area.

The method may include the step of using optical fibres to transmit the light reflected by the area on the surface of the rail. Preferably the scanning head is mounted such that the ends of the optical fibres are held near to the rail, the ends of the fibres preferably being approximately perpendicular to the rail.

Preferably the method includes the step of using a light sensitive sensor to detect the light transmitted by a bundle of optical fibres. The method may include the step of comparing the level of light sensed by one sensor or group of sensors with the level of light sensed by another sensor or group of sensors. The method may include the step of comparing the differences between levels of light sensed by different sensors or groups of sensors with a threshold difference level and registering an alarm state if one or more differences exceed the threshold.

The method may further include the step of directing light towards the area on the surface of the rail from a light source provided within the apparatus. This light may be laser light.

The method may further include the step of spreading a substance on the rail, to highlight the differences in reflective properties between damaged and sound rails. The substance may be spread or wiped onto the rail surface, to force it into damaged areas or cracks. The use of additional light sources and wavelengths to enhance the observability of the defects, such as, for example, by producing fluorescence of the highlighting substance may be advantageous.

Preferably the levels of light detected by the scanning head are recorded. The light levels may be analysed contemporaneously or analysed subsequently using the recorded data.

Preferably the method includes the step of relating the detected levels of light or difference levels to the position of the vehicle at the time the light was detected.

The method may include the step of recording the light level data for a particular track and comparing subsequent data for the same track with the previously recorded data, to detect any changes indicating rail damage.

The method may include the steps of directing beams of coherent electromagnetic radiation towards the rail and analysing the reflected radiation to provide an indication of damage to the rail.

Preferably the radiation is laser light, and the analysis provides an indication of the distance travelled by the radiation.

Preferably the radiation is directed towards the rail and the reflected radiation detected continuously or periodically as the rail vehicle moves.

Preferably characteristics of the detected radiation are recorded, and the detected radiation is related to the position of the vehicle at the time the radiation was detected.

Preferably the detected radiation is compared with previously detected radiation, for another part of the rail, or the same part of the rail on an earlier occasion, to highlight anomalies.

The distance travelled by the radiation may be determined to indicate any breaks in the rail which have opened up.

The method may further or alternatively include the step of taking a temperature reading indicative of the temperature of the rail and analysing the temperature reading to provide an indication of damage to the rail.

By simultaneously detecting the sound produced by the vehicle running on the rail and the temperature near the rail, the method may pick up anomalies more reliably than by using sound alone.

Preferably temperature readings are taken continuously or periodically, preferably in rapid succession, as the rail vehicle moves.

The temperature reading may be provided by an infrared sensor positioned on the rail vehicle, near the rail.

Preferably the temperature readings are recorded. The temperature readings may be analysed contemporaneously and only anomalously high readings recorded or all the data may be recorded and analysed subsequently.

Preferably the method includes the step of relating the temperature readings to the position of the vehicle at the time the reading was taken.

Preferably the method includes the step of taking temperature readings at each of two or more spaced locations, the readings being indicative of the temperatures of different, respective parts of the rail.

The method may include the step of comparing the respective temperature readings with one another. Alternatively or additionally the method may include the step of comparing a temperature reading with an average reading over a time period prior to the reading.

The method may include the step of checking for a significant increase in the magnitude of the temperature reading, in particular for a spike in the temperature reading with respect to the position of the vehicle on the rail.

The method may include the step of taking temperature readings indicative of the temperature of each of two adjacent rails in a pair of rails and comparing the temperature readings for the two rails, to check for abnormalities.

The method may include the step of recording the temperature readings for a particular track and comparing subsequent temperature readings for the same track with previous readings to detect changes indicating damage.

According to the invention, there is further provided a method of detecting damage in a rail, the method including the steps of running a vehicle on the rail, detecting light (which may be in the form of laser light) reflected by an area on a surface of the rail, taking a temperature reading indicative of the temperature of the rail and analysing the detected light and the temperature readings to provide an indication of damage to the rail.

By simultaneously detecting the light reflected by the rail and taking a temperature reading of the rail, the method may pick up abnormalities more reliably than if a single one of those methods was to be used alone. Any of the features of light detection and/or temperature detection discussed in the preceding paragraphs may be utilised.

According to the invention there is further provided a method of detecting damage in a rail, the method including the step of running a vehicle on the rail and providing detection means for providing an alert only when a complete break of the rail is detected. Preferably the detection means includes a combination of two or more of sound detection, optical detection and temperature detection. The sound detectical, optical detection and/or temperature detection may include any of the features discussed in the preceding paragraphs.

According to the invention there is further provided apparatus for detecting damage in a rail, the apparatus including means for detecting sound produced by the rail as a result of a vehicle running on the rail and means for analysing the detected sound to provide an indication of damage to the rail.

Preferably the sound detection means includes means for detecting sound within the audible spectrum.

The apparatus may include a sound collection apparatus, which may include a microphone device and which may further include a sound collection tube or horn. The apparatus may include means for mounting the sound collection apparatus on a train, to be positioned near the rail in use. The microphone device may be located remotely from the rail itself, and may be placed inside an insulated container in order that extraneous sounds and vibrations are minimised.

The apparatus may include noise cancellation means for minimising unwanted sounds. The apparatus may include a sound collection tube or horn, for optimising the transfer of sound to the microphone and means for analysing the detected sound.

Preferably the apparatus includes means for recording the detected sound. The apparatus may include means for analysing the detected sound contemporaneously.

Preferably the apparatus further includes means for recording the position of the vehicle. The apparatus may include means for calculating the position of the vehicle with reference to a start position and/or by trackside position indicators, which may be used to update the recorded position. Preferably the apparatus includes means for determining the position using a satellite based global positioning system (GPS).

Preferably the apparatus includes means for relating the detected sounds to the position of the vehicle at the time the sound was detected.

The apparatus may include processor means for analysing the frequencies within the detected sound, for example by Fourier analysis or a similar method.

The processor means may include means for comparing the analysed sound with a reference sound fingerprint based on the sound produced by an unbroken rail. Alternatively or additionally the processor means may include means for checking the analysed sound for particular frequencies such frequencies tending to indicate damage. Alternatively or additionally the processor means may include means for checking the analysed sound for the absence of particular frequencies, the absence of such frequencies tending to indicate damage.

Alternatively or additionally, the apparatus may include means for simultaneously detecting the sound produced by a vehicle running on each of two adjacent rails in a pair of rails and comparing the analysed sound from each of the rails to check for abnormalities.

The apparatus may further include a scanning head for mounting on the rail vehicle, the scanning head comprising light detection means for producing an output indicating levels of light reflected by an area on a surface of the rail and processor means for analysing the output of the light detection means and providing an indication of damage to the rail within the area.

Preferably the light detection means includes a plurality of optical fibres. The light detection means may comprise a plurality of bundles, each including a plurality of optical fibres.

The apparatus may include means for mounting the scanning head on the rail vehicle such that in use ends of the optical fibres are held near to the rail, the optical fibres preferably being approximately perpendicular to the rail near their ends. The ends of the optical fibres are preferably held between 10 and 100 mm from the rail surface.

Preferably the scanning head further includes a plurality of light sensitive sensors for detecting the light passing along the optical fibres. The scanning head may include a light sensitive sensor connected to each bundle of optical fibres for detecting the light reflected from the rail surface and passing along those optical fibres. The sensor may be mounted near ends of the fibres remote from the rail in use.

Preferably the processor means includes a comparator for comparing the levels of light sensed by a respective sensor with the levels of light sensed by another sensor. The processor means may include means for comparing the light levels sensed by each sensor with the light levels sensed by one or more other sensors. The processor means may include means for comparing the differences between the light levels sensed by the various sensors with a threshold difference level and registering an alarm state if one or more differences exceed the threshold.

The apparatus may further include a light source for directing light towards the area on the surface of the rail. The light source may be located adjacent to the optical fibres. Alternatively, the light source may be positioned to direct light down one or more of the optical fibres.

The apparatus may further include means for spreading a substance on the rail, to highlight the difference in reflective properties between damaged and sound rails. The substance may include a liquid, a solution or a powder and may be adapted to accumulate or concentrate in cracks and depressions in the rail surface. The substance is preferably more light reflective or light absorbent than rail material. The apparatus may include a storage receptacle for the substance and metering means for metering the substance onto the rail. The apparatus may further include scraper means or air blowing means for spreading the substance on the rail and wiping it into damaged areas or cracks.

The apparatus may include means for directing beams of coherent electromagnetic radiation towards the rail and analysing the reflected radiation, to provide an indication of damage to the rail. The radiation is preferably laser light. The distance travelled by the laser light may be determined, and thus any breaks in the rail which have opened up may be detected.

The apparatus may further include means for taking a temperature reading indicative of the temperature of the rail, and means for analysing the temperature reading to provide an indication of damage to the rail.

The apparatus may include an infrared sensor and means for mounting the sensor on the rail vehicle, so as to be near the rail in use.

Preferably the apparatus includes means for recording the temperature readings. The apparatus may include means for analysing the temperature readings contemporaneously.

Preferably the apparatus includes means for relating each temperature reading to the position of the vehicle at the time the temperature reading was taken.

The apparatus may include means for taking temperature readings at each of two spaced locations, the readings being indicative of the temperatures at respective, different parts of the rail.

The apparatus may include processor means for comparing the magnitudes of the temperature readings at the two spaced locations. The processor means may further or alternatively include means for checking for a significant increase in the magnitude of the temperature reading, in particular for a spike in the temperature reading with respect to the position of the vehicle on the rail.

An embodiment of the invention will be described for the purpose of illustration only with reference to the accompanying drawings in which:

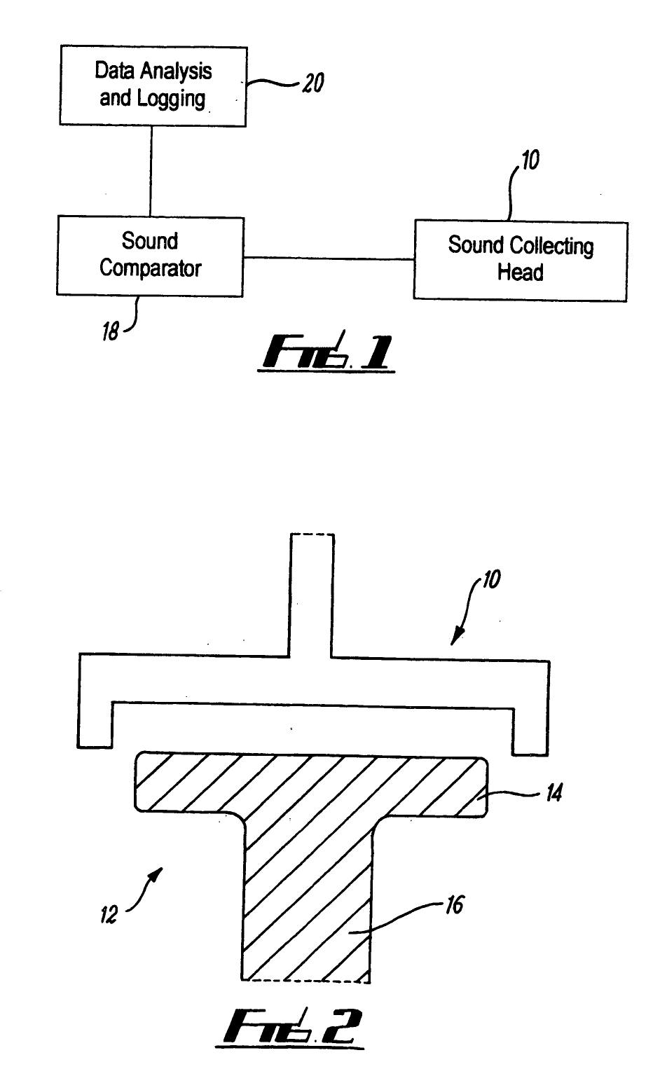

FIG. 1 is a schematic layout of an apparatus for use in accordance with one aspect of the invention;

FIG. 2 is a diagrammatic vertical section of a sound collection head for use with the method/apparatus of FIG. 1;

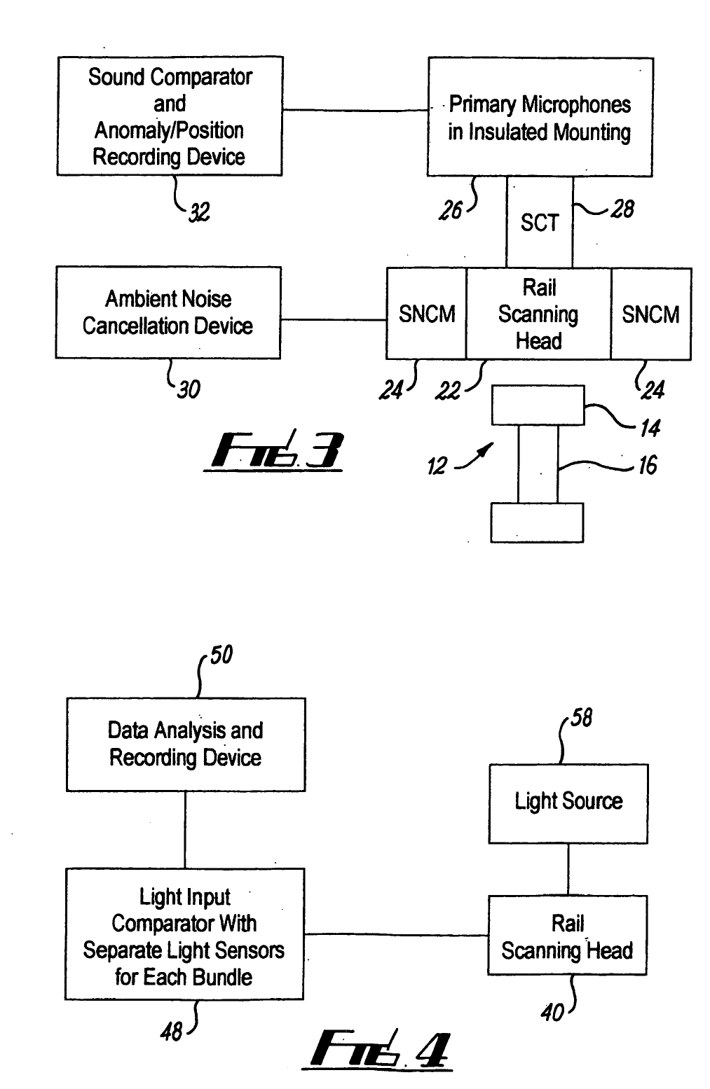

FIG. 3 is a schematic layout of an apparatus in accordance with a further aspect of the invention;

FIG. 4 is a schematic layout of an apparatus for use in accordance with a further aspect of the invention;

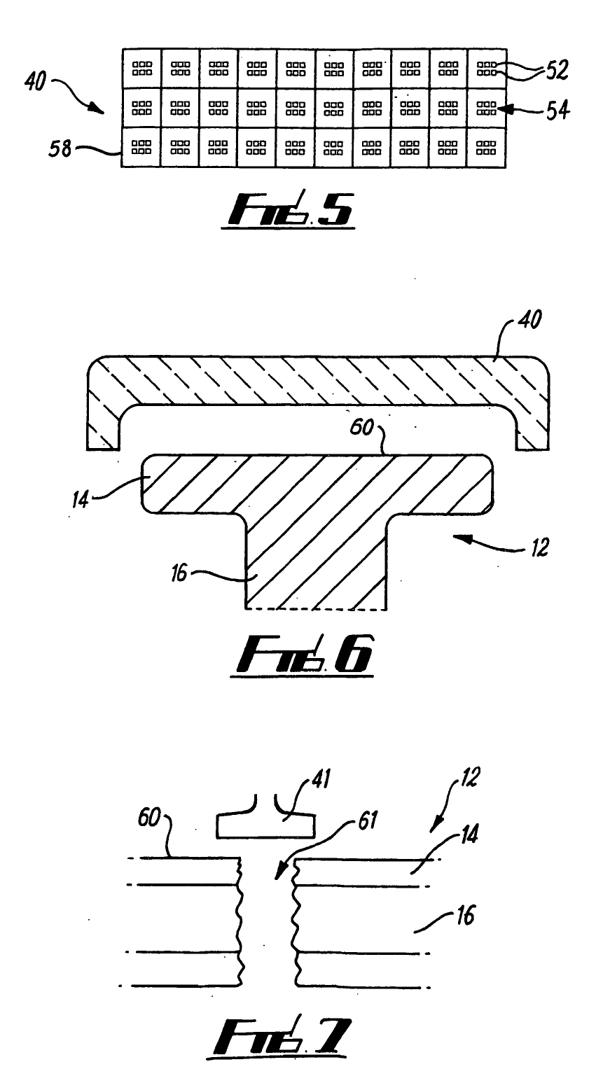

FIG. 5 is a diagrammatic plan view from below of fibre optic cable bundles for use with the invention;

FIG. 6 is a diagrammatic sectional view of a scanning head for use with the invention, located above a rail;

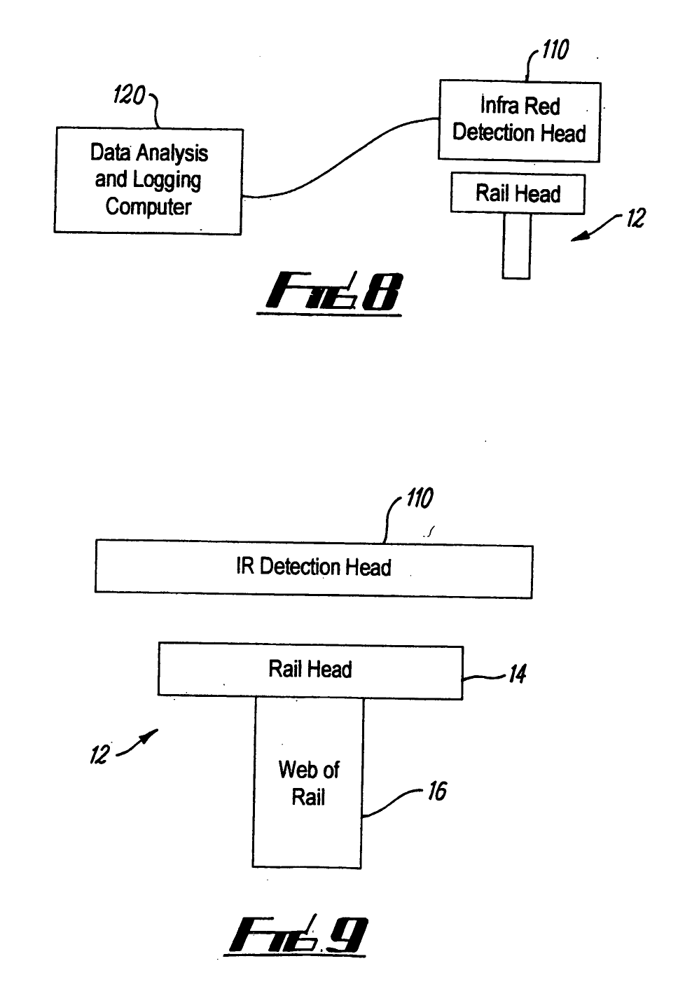

FIG. 7 is a diagrammatic sectional view of apparatus for use in accordance with a further aspect of the invention;

FIG. 8 is a schematic layout of apparatus for use in accordance with a further aspect of the invention; and

FIG. 9 is a diagrammatic vertical section of an infrared detection head positioned above a rail for use with the method/apparatus of the invention.

Referring to FIGS. 1 and 2, a sound collecting head 10 is positioned close to a rail 12 which includes a rail head 14 and a web 16.

The sound collecting head 10 is connected to a sound comparator 18 which in turn is connected to a processor 20, for data analysis and logging.

The sound collecting head 10 is mounted on a rail vehicle (not illustrated) relatively near the point of contact of a wheel of the vehicle with the rail 12. The sound collecting head 10 will be mounted in front of the first wheels of the train or behind the last wheels. (In service, the front and rear of train normally reverse on a return journey).

The sound collecting head 10 is able to detect sound throughout a significant frequency range, typically including at least a range of audible frequencies.

The sound comparator 18 is able to receive frequencies recorded by the sound collecting head 10 and compare these with predetermined frequencies.

The processor 20 is able to record the output of the sound comparator and to link that with position information, information about previous readings, etc., as described in more detail hereinafter.

In use, the rail vehicle runs over the rail 12 at normal speed, typically during normal commercial operation. As the wheels of the vehicle run over the rail, they cause the rail to vibrate and to emit a characteristic sound. The sound collection head 10 detects the sound produced by the vehicle running on the rail and passes a signal representing this sound to the sound comparator 18. The sound is analysed to break it down into its component frequencies and their magnitudes, by using Fourier analysis or a similar method. The sound comparator 18 then compares the frequency spectrum produced by the sound collecting head 10 with a reference frequency spectrum. Alternatively, the sound comparator 18 may check for specific frequencies at specific magnitudes or sets of frequencies, or the absence of certain frequencies, depending upon various predetermined factors.

The comparator may also check for a drop in amplitude of the sound or a sudden increase in amplitude, in particular a “spike” or series of spikes of high amplitude.

The output from the sound comparator 18 is passed to the processor 20. The processor 20 records the output and relates it to the position of the vehicle. This information relating to the position of the vehicle may be obtained from a GPS system, from trackside position markers or from the start position of the train.

The processor 20 may carry out a continuous analysis of the sound produced by the rail and only record anomalous readings and their related position, or may store such sound against the position of the rail, for subsequent analysis. In either case, defects in the rail may be detected by the sound spectrum being different from that expected for an undamaged rail.

Both rails 12 in a track may be simultaneously analysed and compared. This automatically takes account of variations in the sound caused by changes in temperature, weather conditions, etc. but has the disadvantage that cracking may occur simultaneously in both rails in a pair, and the tensile stresses in the two rails may be different, leading to some differences in the sound produced.

The sound recorded may be compared with previous recordings for the same rail which are used to build up a picture of the standard sound fingerprint of that rail. Thus, any changes in that fingerprint may indicate damage.

By running the above system on standard rail vehicles, a picture may be built up of the sound spectrum of the whole rail network. This can allow immediate detection of any significant changes in a rail.

Because the system may be run on standard rail vehicles, it does not cause any disruption to normal train services.

It should be borne in mind that the shape illustrated is not representative of any preferred shape or arrangement of the sound collection head. Many variations are possible to optimise the function, including the use of a horn-shaped head, or a porous medium can be used to minimise noise produced by air travelling over the open end of the collection head. (Materials such as porous ceramic filter media are particularly suitable of this purpose).

The above apparatus and method may be enhanced by using noise cancellation techniques to reduce or eliminate the masking effects of noise produced by the rail vehicle itself or by intermittently varying contact of the wheels with the tracks, such as when the vehicle sways from one side to another, or when it experiences sideways forces due to cornering, aerodynamic loads, etc.

FIG. 3 illustrates a schematic layout of one embodiment of the invention incorporating noise cancellation. The apparatus is generally similar to that illustrated in FIGS. 1 and 2, in that it includes means for detecting, recording and analysing the sound produced by a rail 12 including a rail head 14 and a web 16.

However, in this embodiment of the invention, a rail scanning head 22 is contained between secondary noise cancellation microphones 24. The rail scanning head 22 is connected to primary microphones 26 via a sound collection tube 28. The primary microphones 26 are provided within a noise insulated mounting.

The length and shape of the sound collection tube 28 may be designed specifically to match the characteristics of the sound generated by a cracked or broken rail, so that the sound that is required to be heard is transmitted efficiently, whilst other sounds with different characteristics are eliminated or reduced in intensity. Thus, the sound input to the primary microphones 26 is optimised.

The apparatus of FIG. 3 further includes an ambient noise cancellation device 30. The secondary noise cancellation microphones 24 are able to feed a ambient sound to the ambient noise cancellation device 30, for cancellation of that noise.

The apparatus further includes a primary sound analysis and comparison device 32, which works in a similar way to that described in relation to the previous embodiment. However, in this case the noise used for analysis comprises primarily the noise produced by the rail itself, absent unwanted noise.

The location of the sound cancellation microphones is very important, because they must be positioned at sufficient angle and distance from the open end of the sound collection tube or horn in order to collect the unwanted ambient noise rather than the noise produced by the rail. Although FIG. 3 illustrates these microphones near the rail, they may advantageously be located further from the rail than the primary microphones, in order that they collect primarily background (unwanted) noise. The timing difference between receiving the unwanted ambient noise by the sound cancellation system and it reaching the primary sound collection system must be allowed for in the operation of the sound cancellation system. The number of sound cancellation microphones used may vary with each installation design but is preferably not less than two and the use of four located at 90° intervals and equidistant to the primary sound collection may be preferred. Further the design of the external opening of the sound collection system for the secondary noise cancellation microphones is preferably the same as that of the primary sound collection system, in order that the noise generated by the action of the movement of the air passing over the openings is the same, thereby assisting in the cancellation of this unwanted noise.

The following factors may also be taken into account, to enhance the usefulness of the noise detected by the primary microphones 26:

a) design of the shape of the open end of the sound collection system to minimise the effect of external airflow,

b) monitoring the speed of the airflow and passing pressured air down the sound collection system so that the speeds of the airflow inside and outside the tube are approximately equalised, thus eliminating or at least minimising noise generated from this source,

c) the incorporation of an additional forward facing air duct designed to automatically feed approximately the correct volume of airflow to provide a small positive pressure in the sound collection tube or horn, so that a small outflow is maintained out all speeds,

d) to partially close the end of the sound collection tube or horn by means of a porous medium, so that sound may pass through whilst airflow is impeded and hence unwanted noise generation is minimised.

e) any combination of all the methods identified.

The sound cancellation may be performed electronically within the microprocessor as an alternative or in addition to the sound collection tube 28.

A break in the rail has a significant effect on the magnitudes and frequencies of sound produced by the rail. In particular, a break prevents the whole rail vibrating continuously up its length; instead the rail will vibrate primarily between the train position and the break point. Further, as the vehicle wheels move over the break, depending on the shape of the broken ends of the rails, and the amount of longitudinal stress relief, which produces a gap between them, a significant, loud “bang” may occur as one part of the rail slams down against the other.

This effect occurs whenever the angle of the break away from the vertical and the length of the gap resulting from longitudinal movement of the rail (due to relief of the tensile stress imposed when the rail was laid) together lead to any overlap of the ends of the broken rail in the horizontal plane. Thus analysis of the sound produced by the impact of the longitudinal overlap of the section ends of the rail allows the detection of breaks. In particular, the sound will be transmitted along the rail and recorded as a series of peaks of reducing magnitude with time intervals which are related directly to the distances between the train wheels and the train speed. This provides a highly characteristic signature, which is particularly valuable as an indicator of a break.

Referring to FIGS. 4 to 6, there is illustrated an alternative arrangement for detecting damage in rails, which may be used separately or in conjunction with the apparatus of FIGS. 1 to 3.

A rail scanning head 40 is positioned close to a rail 12 which includes a rail head 14 and a web 16.

The rail scanning head 40 is connected to a light input comparator 48 which in turn is connected to a processor 50, for data analysis and logging.

The scanning head 40 is mounted on a rail vehicle such as a train, (not illustrated). Referring to FIG. 5, the scanning head 40 includes a plurality of optical fibres 52 arranged in bundles 54. The scanning head 40 includes a plurality of segments 58, each segment comprising a row of three bundles 54. In reality, the scanning head 40 would include many more optical fibres and bundles than are illustrated.

Referring to FIG. 4, a light source 58 is located near to the rail scanning head 40.

In use, the rail vehicle runs along the rail at normal speed, typically during normal commercial operation. The light source 58 directs light onto an area of rail surface 60 underneath the scanning head 40. Light is reflected by the surface 60 and passes into the optical fibres 52.

The light input comparator 48 includes a plurality of light sensors (not illustrated), each light sensor being associated with one bundle 54 of optical fibres. Each light sensor senses the total amount of light passing through all the optical fibres within a respective bundle 54. The comparator 48 compares the outputs of the various sensors with the outputs of other sensors, to provide difference values. The difference values may be compared with a predetermined threshold difference value and an alarm signal produced if any of the difference values exceeds this threshold. This type of alarm signal will usually relate either to surface defects in the rail known as spalling, where small flakes are lost from the surface, or to the gap between the broken ends of the rail if it is wide enough to be resolved by the equipment.

The output from the comparator 48 is passed to the processor 50. The processor 50 records the output from the comparator and relates it to the position of the vehicle. The information relating to the position of the vehicle may be obtained from a GPS system, from trackside position markers or from the start position of the train.

The processor 50 may carry out a continuous analysis of the light difference levels or actual light levels reflected from the rail or may store such information against the position of the rail, for subsequent analysis. In either case, defects in the rail may be detected by the light levels or difference levels being different from those which would be expected for an undamaged rail.

The light difference levels for the rail may be compared with previous recordings for the same rail which are used to build up a picture of the standard light difference level fingerprint of that rail. Thus, any changes in that fingerprint may indicate damage.

As an alternative to utilising optical fibres in the scanning head, it may be possible to use high resolution video cameras to produce an image for analysis. In this case, each pixel or group of pixels within the image is analogous to the groups of optical fibres described previously. The picture may be analysed by the processor 50 or stored for subsequent analysis and comparison with previous images for the same rail.

Alternatively, laser scanning of the rail could be utilised, using the level of reflected light and/or the path length measurement to identify surface defects or complete breaks.

Referring to FIG. 7, there is illustrated a further embodiment of the invention in which laser scanning of the rail is utilised to detect a break. Referring to FIG. 7, a laser scanning head 41 is positioned above a rail 12 which includes a rail head 14 and a web 16. The laser scanning head 41 is connected to a comparator and a processor (not illustrated) in a similar manner to that described in relation to the scanning head 40.

The laser scanning head 41 is also mounted on a rail vehicle such as a train (not illustrated).

The laser scanning head 41 is able to produce coherent laser light and direct this light towards the rail. In use, the rail vehicle runs along the rail at normal speed, typically during normal commercial operation. The laser scanning head directs laser light onto an area of rail surface underneath the laser scanning head 41. The laser light is reflected by a surface 60 of the rail 12 and detected by the scanning head.

The comparator and processor may process light levels as discussed in relation to the previous embodiment. In addition or alternatively, the comparator and processor are able to calculate the distance travelled by the laser light. This provides an indication of the distance between the scanning head 41 and the top surface 60 of the rail 12.

When a break 61 occurs in a rail 12, stresses within the rail may be relieved by the break opening up as illustrated in FIG. 7. This can result in a gap of anything from zero (in hot ambient conditions) to more than 100 mm (in cold ambient conditions). The use of the laser scanning head 41 will therefore easily detect the increase in distance to the next solid surface at the break position and hence provide a clear indication of the break, provided that the width of the gap is within the resolution of the laser equipment at the speed the vehicle carrying it is moving.

The significant gap in the rail as illustrated in FIG. 7 will also be clearly detected in the method according to FIGS. 4 to 6, as the gap will reduce the intensity of the light reflected compared to that reflected from the top surface 60 of the rail. Hence, any significant gaps (within the resolution of the system at the speed the vehicle carrying the equipment is moving) will be detected by a sharp drop in the intensity of the light received by the sensors across the whole width of the scanning head.

In this way, the visual appearance of a break in the rail allows for early detection.

In any of the optical scanning embodiments of the invention, a transparent cover or lens may be provided to protect the optical fibres/light receiving means. The cover could be provided with a rotating or sliding wiper arrangement to keep it clean.

FIGS. 8 and 9 illustrate an alternative arrangement for detecting damage in rails, which may be used separately or in conjunction with the apparatus of FIGS. 1 to 3 and/or FIGS. 4 to 6, or 7.

Referring to FIGS. 8 and 9, an infrared detection head 110 is positioned close to a rail 12 including a rail head 14 and a web 16.

The infrared detection head 110 is connected to a processor 120, for data analysis and logging.

The infrared detection head 110 is mounted on a rail vehicle such as a train (not illustrated) relatively near the rail 12, in use, and preferably at the extreme rear of the train. A second infrared detection head (not illustrated) is spaced apart slightly from the first (perhaps 50 to 150 mm away) and is also mounted at the rear of the train in a similar manner to the detection head 110.

The infrared detection head 110 is able to detect infrared radiation throughout a range of frequencies. The processor 120 is able to record the output of the infrared detection head and to compare that output with a simultaneous reading from the second infrared detector located nearby and/or with outputs recorded a short time previously as described in more detail hereinafter.

In use, the rail vehicle runs over the rail 12 at normal speed, typically during normal commercial operation. The infrared detection head 110 detects infrared (heat) levels near the rail. The output from the infrared detection head is passed to the processor 120. The processor 120 may break the infrared down into component frequencies and their magnitudes or may simply record an overall magnitude value. The processor 120 also relates the output of the infrared detection head 110 to information referring to the position of the vehicle. This information may be obtained from a GPS system, from trackside position markers or from the start position of the train. The output from the second infrared detector is treated similarly.

The processor 120 may carry out a continuous analysis of the infrared readings or may store such infrared readings against the position of the rail, for subsequent analysis.

The infrared detected near the rail will obviously depend partly upon weather conditions, etc. However, in certain cases a broken or cracked rail will tend to produce a significant spike in the infrared reading. This is because the presence of the break causes two separated parts of the rail to rub together as the train passes over the rail, the friction between the two parts causing significant heat. Experience may also demonstrate that the spikes tend to be of a particular frequency of infrared. Thus, the processor 120 may look for spikes and particular infrared frequencies and use these to determine that a break is present in the rail. The readings from the two spaced detectors may be compared, to detect an anomalous reading.

As an alternative to comparing the infrared readings from the two detectors, both rails in a track may be simultaneously analysed and compared. However, this has the disadvantage that cracking may occur simultaneously in both rails in a pair.

There is thus provided an improved method and apparatus for detecting damage to rails. The method overcomes many of the disadvantages associated with the prior art and is significantly less disruptive to commercial operation of the railway than prior art methods.

The method and apparatus as described enables the detection of complete breaks in rails as soon as a train carrying the equipment proposed by the method passes over it. Prior art methods rely on attempts to detect cracks at an early stage, before such cracks result in an actual break in the rail. This has necessitated the use of extremely complex equipment which is able to scan a rail thoroughly, but only at an extremely slow rate. Also, because of the high sensitivity of the equipment, false positives are very common and hence manual inspection is also required. This is very slow and causes serious disruption to the normal rail service. These problems result in individual rails being scanned relatively infrequently or in only random testing of some of the rail network occurring.

The method of the invention focuses on detection of a complete break in a rail at the earliest possible time. It has been found that when a complete break occurs, there is generally a period of around five to ten days before a further break may develop in a location spaced a short distance away from the first break, this resulting in the possible loss of a short section of rail and the almost certain consequent de-railment of trains. Thus, provided that a break is detected quickly and appropriate action is taken, it is not always necessary to detect a crack before the break actually occurs. The above invention aims primarily to detect breaks in rails rather than cracks which may form breaks. By mounting the relevant apparatus on a significant proportion of the train fleet (probably 5-10%) in normal commercial use, the scanning of rails is not disruptive and may be carried out continuously. Thus, any break in the rail should be detected almost immediately, i.e., when the first train carrying the scanning equipment described passes over the break. Indeed the acoustic method may detect breaks caused by the train carrying the scanning equipment if that occurs.

By combining two of the three of sound analysis, optical scanning (including the laser option) and temperature analysis of the rail, the possibility of false positives or missing breaks is much reduced. It is also possible to combine all three methods on a single vehicle. Preferably the acoustic method is always included in the combination selected, and experience in use may allow its use singly to perform the function required. The preferred method uses the acoustic and optical/laser methods in combination.

It is important that the new method is as close as possible to being 100% reliable in detecting a rail break on the first occasion that a train fitted with the equipment based on the method passes over it, so that action can be taken to prevent a second break as soon as possible, such as closing that section of line, or imposing speed restrictions prior to replacement of the rail.

In order to achieve this it is critical to take account of the fact that rail breaks can produce considerably different results in terms of the shape of the broken ends of the rail, and the gap between them, which occurs due to the relief of the tensile stress put into the rail when it is welded in place in the track. The break allows the rail either side to shrink slightly, which can produce a gap ranging from near zero up to about 100 mm.

Additionally, the angle to the vertical at which the break occurs can significantly affect the nature of the signals produced by the break.

In the case of a vertical break with a large gap and therefore no overlap in the horizontal plane there cannot be any contact between the broken ends to produce any friction or impact between the two so there cannot be any elevation of temperature or strong acoustic signal from the break itself and hence these indications will be absent. Therefore reliance must be placed on the lack of transmission of the normal acoustic signal across the break, plus the optical technique being able to detect the gap.

In the case of a vertical break with no horizontal plane overlap and only a small gap the optical technique may not have sufficient resolution to detect it, and hence reliance must placed on the acoustic technique to detect the loss of sound transmission along the rail, plus potentially the elevation of temperature due to friction between the ends of the rail as they flex under the load as the train wheels move over them. In addition, observation of samples of broken rail has shown evidence that the action of the train wheels coming into heavy contact with the top edge of the broken ends of the rail results in the broken ends being sufficiently flexed to move the top of the rail surface out of the normal horizontal plane of the track by a significant amount. This leads to increased wear at the top corners of the broken ends of the rail, which is a clear indicator that an enhanced acoustic output will be produced.

Therefore in this case there will be two different acoustic indications, firstly the instantaneous loss of acoustic signal as the sound collection tube or horn passes over the break and onto the next section of rail, to be followed very shortly afterwards by a sequence of peaks of reducing magnitude with the time intervals between the peaks being directly related to the distances between the train wheels, and the speed of the train. This series of acoustic events will be highly characteristic and very easily detectable.

In the case of the type of breaks which are angled away from the vertical, and thus have some degree of overlap in the horizontal plane, the same characteristic acoustic output as occurs with the contact between the train wheels and the top corner of the end of the broken rail will be generated. In addition the loss of sound transmission at the break will give a clear second acoustic indication of the problem, with the possibility of the optical technique also detecting the gap at the break, giving a third indication of the break.

In the unlikely case of a break with the two ends in very close contact, (perhaps because of very high ambient temperatures but not seen as a usual break configuration) so that the usually very definitive loss of acoustic transmission up the rail is not complete, there will still be the characteristic series of impacts of the train wheels with the top edge of the broken end of the rail due to rail flexing under load to provide a reliably-detected indicator of the break, albeit that it is the sole indicator of the four possibilities.

Another case where the detection of the break relies on only one of the methods is where there is a clean vertical break without any horizontal plane overlap occurring at the mid-point of a sleeper support point. In this case the rail will not flex abnormally, and some sound may still be transmitted around the break through the rail baseplate, the sleeper and the metal clips securing the rail to the base plate. It is still highly likely that the much reduced acoustic amplitude will be detected, but in the unlikely event that it is not, there is still the possibility that the optical technique will detect the gap in the rail which normally occurs due to the tensile stress relief effect when a break occurs.

Thus it can be seen that by using both the acoustic and optical techniques together, it is highly likely that every break, whatever configuration or location along the rail, it will be detected by at least one, possibly two, and often three different techniques.

The elevated temperature technique may also provide a back-up indicator to support the other two, but will generally be a secondary method unless it proves in service to be exceptionally reliable, or provides a unique indicator in circumstances where the acoustic and optical techniques fail to detect a break.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of detecting damage in a rail, the method including the steps of running a vehicle on the rail, detecting sound produced by the rail as a result of the vehicle running on the rail, using sound sensing apparatus positioned on the rail vehicle, near the rail, and analysing the detected sound to provide an indication of damage to the rail.

2. A method according to claim 1, wherein the vehicle is a train running a normal commercial service.

3. A method according to claim 1 or claim 2, wherein the sound is detected continuously or periodically as the rail vehicle moves.

4. A method according to any preceding claim, wherein at least some of the sound detected is within the audible spectrum.

5. A method according to any preceding claim, wherein the sound sensing apparatus includes a microphone device.

6. A method according to any preceding claim, wherein the method includes the step of partially or completely cancelling unwanted background sounds.

7. A method according to any preceding claim, wherein the detected sound is recorded.

8. A method according to any preceding claim, including the step of recording the position of the vehicle.

9. A method according to claim 8, including the step of relating the detected sound to the position of the vehicle at the time the sound was detected.

10. A method according to any preceding claim, including the, step of analysing the frequencies within the detected sound spectrum by Fourier analysis or a similar method.

11. A method according to any preceding claim, wherein the analysed sound is compared with a reference sound fingerprint based on the sound produced by an unbroken rail.

12. A method according to any preceding claim, including the step of checking for particular frequencies present within the analysed sound, such frequencies tending to indicate damage.

13. A method according to any preceding claim, including the step of checking for the absence of particular frequencies within the analysed sound, the absence of such frequencies tending to indicate damage.

14. A method according to any preceding claim, including the step of checking for a drop in amplitude of the sound produced by the rail and/or a significant increase in amplitude of the sound produced by the rail, in particular for a spike in the amplitude with respect to the position of the vehicle on the rail.

15. A method according to any preceding claim, including the step of simultaneously detecting the sound produced by the vehicle running on each of two adjacent rails in a pair of rails and comparing the analysed sound from each of the rails to check for abnormalities.

16. A method according to any preceding claim, including the step of recording the data for a particular track and comparing subsequent data for the same track with the previously recorded data, to detect any changes indicating rail damage.

17. A method according to any preceding claim, further including the step of detecting light reflected by an area on a surface of the rail and analysing the detected light to provide an indication of damage to the rail within the area.

18. A method according to claim 17, wherein the reflected light is detected continuously or periodically as the rail vehicle moves, the area on the surface of the rail thus continuously changing.

19. A method according to claim 18, wherein the method utilises apparatus including scanning head provided with light detection means, the method including the steps of mounting the apparatus on a rail vehicle, using the light detection means in the scanning head to produce an indication of levels of light reflected by an area on a surface of the rail and analysing the output of the light detection means to provide an indication of damage to the rail within the area.

20. A method according to any of claims 17 to 19, the method including the step of using optical fibres to transmit the light reflected by the area on the surface of the rail, the scanning head being mounted such that the ends of the optical fibres are held near to the rail.

21. A method according to claim 20, including the step of using a light sensitive sensor to detect the light transmitted by a bundle of optical fibres.

22. A method according to claim 21, including the step of comparing the level of light sensed by one sensor with the level of light sensed by another sensor or group of sensors.

23. A method according to claim 22, the method including the step of comparing the differences between levels of light sensed by different sensors or group of sensors with a threshold difference level and registering an alarm state if one or more differences exceed the threshold.

24. A method according to any of claims 17 to 23, further including the step of directing light towards the area on the surface of the rail from a light source provided within the apparatus.

25. A method according to any of claims 17 to 24, including the step of spreading a substance on the rail, to highlight the differences in reflective properties between damaged and sound rails.

26. A method according to any of claims 17 to 25, wherein the levels of light detected by the scanning head are recorded and related to the position of the vehicle at the time the light was detected.

27. A method according to any of claims 17 to 26, including the step of recording the light level data for a particular track and comparing subsequent data for the same track with the previously recorded data, to detect any changes indicating rail damage.

28. A method according to any preceding claim, the method including the steps of directing beams of coherent electromagnetic radiation towards the rail and analysing the reflected radiation to provide an indication of damage to the rail.

29. A method according to claim 28 wherein the radiation is laser light.

30. A method according to claim 28 or claim 29, wherein the analysis provides an indication of the distance travelled by the radiation.

31. A method according to any of claims 28 to 30, wherein the radiation is directed towards the rail and the reflected radiation detected continuously or periodically as the rail vehicle moves.

32. A method according to claim 31, wherein characteristics of the detected radiation are recorded.

33. A method according to claim 32, wherein the detected radiation is related to the position of the vehicle at the time the radiation was detected.

34. A method according to claim 33 wherein the detected radiation is compared with previously detected radiation, for another part of the rail, or the same part of the rail on an earlier occasion, to highlight anomalies.

35. A method according to any preceding claim, further including the step of taking a temperature reading indicative of the temperature of the rail and analysing the temperature reading to provide an indication of damage to the rail.

36. A method according to claim 35, wherein temperature readings are taken continuously or periodically as the rail vehicle moves.

37. A method according to claim 35 or claim 36, wherein the temperature readings are recorded and related to the position of the vehicle at the time the readings were taken.

38. A method according to any of claims 35 to 37, including the steps of taking temperature readings at each of two or more spaced locations, the readings being indicative of the temperatures of different, respective parts of the rail, and comparing the respective temperature readings with one another.

39. A method according to any of claims 35 to 38, including the step of checking for a significant increase in the magnitude of the temperature reading, in particular for a spike in the temperature reading with respect to the position of the vehicle on the rail.

40. A method according to any of claims 35 to 39, the method including the step of taking temperature readings indicative of the temperature of each of two adjacent rails in a pair of rails and comparing the temperature readings for the two rails, to check for abnormalities.

41. A method according to any of claims 35 to 40, including the step of recording the temperature readings for a particular track and comparing subsequent temperature readings for the same track with previous readings to detect changes indicating damage.

42. A method of detecting damage in a rail, the method including the steps of running a vehicle on the rail, detecting light reflected by an area on a surface of the rail, taking a temperature reading indicative of the temperature of the rail and analysing the detected light and the temperature readings to provide an indication of damage to the rail.

43. A method of detecting damage in a rail, the method including the step of running a vehicle on the rail and providing detection means for providing an alert only when a complete break of the rail is detected.

44. Apparatus for detecting damage in a rail, the apparatus including sensing apparatus, means for mounting the sound sensing apparatus on a rail vehicle, means for detecting sound produced by the rail as a result of the vehicle running on the rail and means for analysing the detected sound to provide an indication of damage to the rail.

45. Apparatus according to claim 44, wherein the sound sensing apparatus in the form of a microphone device including a sound collection tube or horn.

46. Apparatus according to claim 44 or claim 45, including noise cancellation means for minimising unwanted sounds.

47. Apparatus according to any of claims 44 to 46, the apparatus including a sound collection tube, for optimising the transfer of sound to the means for detecting and analysing the detected sound.

48. Apparatus according to any of claims 44 to 47, the apparatus further including a scanning head for mounting on the rail vehicle, the scanning head comprising light detection means for producing an output indicating levels of light reflected by an area on a surface of the rail and processor means for analysing the output of the light detection means and providing an indication of damage to the rail within the area.

49. Apparatus according to claim 48, wherein the light detection means includes a plurality of optical fibres.

50. Apparatus according to claim 49, including means for mounting the scanning head on the rail vehicle such that in use ends of the optical fibres are held near to the rail.

51. Apparatus according to claim 50, wherein the scanning head further includes a plurality of light sensitive sensors for detecting the light passing through the optical fibres.

52. Apparatus according to any of claims 48 to 51, the apparatus further including a light source for directing light towards the area on the surface of the rail.

53. Apparatus according to any of claims 44 to 52, the apparatus further including means for taking a temperature reading indicative of the temperature of the rail, and means for analysing the temperature reading to provide an indication of damage to the rail.

54. Apparatus according to claim 53, the apparatus including an infrared sensor and means for mounting the sensor on the rail vehicle, so as to be near the rail in use.

55. Apparatus according to any preceding claim, the apparatus further including means for directing laser light towards the rail and analysing the reflected radiation to provide an indication of damage to the rail.

56. A method substantially as herein described with reference to any of the drawings.

57. Apparatus substantially as herein described with reference to any of the drawings.
